(19) United States
(12) Patent Application Publication
(10) Pub. No.: US 2018/0032468 A1
(43) Pub. Date: Feb. 1, 2018

(54) APPARATUS AND METHOD FOR IDENTIFYING AND MANAGING INPUT/OUTPUT (I/O) CHANNEL SPARES FOR CONTROL AND INSTRUMENTATION SYSTEMS IN INDUSTRIAL PLANTS

(71) Applicant: Honeywell International Inc., Morris Plains, NJ (US)

(72) Inventors: Manas Dutta, Bangalore (IN); Ramakrishnan Ganapathi, Bangalore (IN); Abhishek Nikhra, Bangalore (IN)

(21) Appl. No.: 15/342,025

(22) Filed: Nov. 2, 2016

Related U.S. Application Data
(60) Provisional application No. 62/369,680, filed on Aug. 1, 2016.

(51) Int. Cl. G06F 13/42; G06F 3/0484

(52) U.S. Cl. CPC G06F 13/4221; G06F 3/0484

(57) ABSTRACT

A method includes identifying input/output (I/O) channels in a control and instrumentation system associated with an industrial plant. The method also includes identifying which of the I/O channels are not in use by the control and instrumentation system. The method further includes generating a graphical user interface identifying the I/O channels not in use by the control and instrumentation system. An indication that at least one I/O channel not in use by the control and instrumentation system is being reserved for use could be received, and the at least one I/O channel can be reserved. An indication that at least one I/O channel in use by the control and instrumentation system is now not in use by the control and instrumentation system could also be received, and the at least one I/O channel could be released so the at least one I/O channel is available for reservation or other use.

### CROSS-REFERENCE TO RELATED APPLICATION AND PRIORITY CLAIM

This application claims priority under 35 U.S.C. § 119(e) to U.S. Provisional Patent Application No. 62/369,680 filed on Aug. 1, 2016, which is hereby incorporated by reference in its entirety.

### TECHNICAL FIELD

This disclosure relates generally to industrial process control and instrumentation systems. More specifically, this disclosure relates to an apparatus and method for identifying and managing input/output (I/O) channel spares for control and instrumentation systems in industrial plants.

### BACKGROUND

Industrial process control and instrumentation systems for manufacturing or processing plants typically include input/output (I/O) modules. I/O modules are used to read data from and write data to field devices, such as sensors, actuators, or other field devices. There are numerous types of I/O modules available, and these I/O modules support different types of inputs and outputs. For example, an I/O module can support one or more analog inputs (AIs), analog outputs (AOs), digital inputs (DIs), digital outputs (DOs), digital input sequences of events (DISOEs), or pulse accumulator inputs (PIs). I/O modules are manufactured by a number of different vendors and have different specifications, form factors, channel densities, communication protocols, and configuration methods. In practice, all channels of existing I/O modules in a control and instrumentation system are often not used. The unused or “spare” I/O channels can be reserved for future use, such as during maintenance or expansion operations when additional I/O channels are needed.

### SUMMARY

This disclosure provides an apparatus and method for identifying and managing input/output (I/O) channel spares for control and instrumentation systems in industrial plants.

In a first embodiment, a method includes identifying I/O channels in a control and instrumentation system associated with an industrial plant. The method also includes identifying which of the I/O channels are not in use by the control and instrumentation system. The method further includes generating a graphical user interface identifying the I/O channels not in use by the control and instrumentation system.

In a second embodiment, an apparatus includes at least one processing device configured to identify I/O channels in a control and instrumentation system associated with an industrial plant and identify which of the I/O channels are not in use by the control and instrumentation system. The at least one processing device is also configured to generate a graphical user interface identifying the I/O channels not in use by the control and instrumentation system.

In a third embodiment, a non-transitory computer readable medium contains instructions that, when executed by at least one processing device, cause the at least one processing device to identify I/O channels in a control and instrumentation system associated with an industrial plant and identify which of the I/O channels are not in use by the control and instrumentation system. The medium also contains instructions that, when executed by the at least one processing device, cause the at least one processing device to generate a graphical user interface identifying the I/O channels not in use by the control and instrumentation system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a portion of an example industrial process control and instrumentation system according to this disclosure;

FIG. 2 illustrates an example device for identifying and managing input/output (I/O) channel spares for control and instrumentation systems in industrial plants according to this disclosure;

FIG. 3 illustrates an example data collection system for identifying and managing I/O channel spares for control and instrumentation systems in industrial plants according to this disclosure;

FIG. 4 illustrates an example sequence chart for identifying and managing I/O channel spares for control and instrumentation systems in industrial plants according to this disclosure;

FIGS. 5 through 7 illustrate an example graphical user interface for identifying and managing I/O channel spares for control and instrumentation systems in industrial plants according to this disclosure; and

FIG. 8 illustrates an example method for identifying and managing I/O channel spares for control and instrumentation systems in industrial plants according to this disclosure.

### DETAILED DESCRIPTION

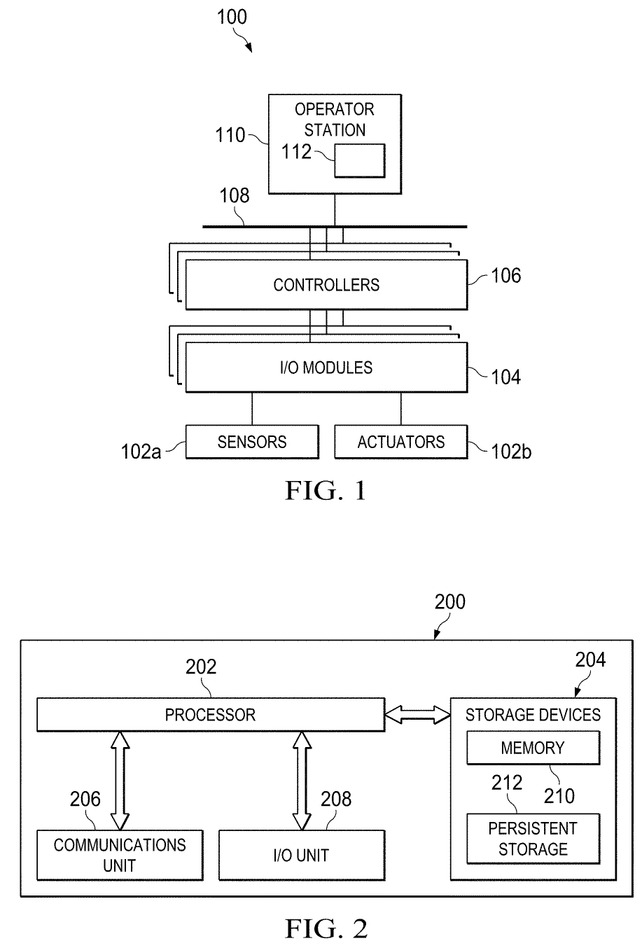

FIGS. 1 through 8, discussed below, and the various embodiments used to describe the principles of the present invention in this patent document are by way of illustration and should not be construed in any way to limit the scope of the invention. Those skilled in the art will understand that the principles of the disclosure may be implemented in any type of suitably arranged device or system.

FIG. 1 illustrates a portion of an example industrial process control and instrumentation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, an I/O module 104 could include fixed number(s) and type(s) of inputs or outputs or reconfigurable inputs or outputs. Example types of reconfigurable I/O circuits are shown in U.S. Pat. No. 8,072,098; U.S. Pat. No. 8,392,626; U.S. Pat. No. 8,656,065; and U.S. Patent Publication No. 2015/0278144 (all of which are hereby incorporated by reference in their entirety). Reconfigurable I/O circuits that support UNIVERSAL CHANNEL TECHNOLOGY available from HONEYWELL INTERNATIONAL INC. are also suitable for use.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, or other states associated with the industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator.

This represents a brief description of one type of industrial process control and instrumentation system that may be used to manufacture or process one or more materials. Additional details regarding industrial process control and instrumentation systems are well-known in the art and are not needed for an understanding of this disclosure. Also, industrial process control and instrumentation systems are highly configurable and can be configured in any suitable manner according to particular needs.

As noted above, industrial process control and instrumentation systems for manufacturing or processing plants typically include I/O modules, which are used to read data from and write data to field devices. There are numerous types of I/O modules supporting different types of inputs and outputs, and I/O modules can have different specifications, form factors, channel densities, communication protocols, and configuration methods. A control and instrumentation system often includes unused or “spare” I/O channels that are unused or reserved for future use, such as during maintenance or expansion operations.

Engineers and other personnel performing maintenance, expansion, or other operations may need to identify spare I/O channels. The personnel may also need to make sure that spare I/O channels that they identify are not then reserved for other projects. However, performing these functions can be difficult for various reasons. For example, there is generally no common method for identifying spare I/O channels for different systems since different control and instrumentation systems follow different methods for modeling I/O modules. The wide variety of available I/O modules from different vendors adds to this complexity. Also, once a spare I/O channel has been identified, it needs to be marked as being reserved for a project so that everyone is aware the spare I/O channel is not available for other uses. This is needed to avoid conflicts of I/O assignments by multiple projects or personnel. In the absence of spare I/O management, multiple expansion projects might plan to use the same I/O channel, plan a cable layout, and lay cable down before discovering that another project has already used the spare I/O channel, which can result in large costs and delays. Further, there is generally no mechanism to free I/O channels that have been reserved for a project and that are no longer needed. In addition, conventional control and instrumentation systems generally do not provide tools or features for identifying and managing spare I/O channels.

In accordance with this disclosure, at least one tool 112 is provided that can be used to discover I/O modules 104 present in one or more control and instrumentation systems and identify unavailable (used) and available or free (spare) I/O channels for each module 104. The tool 112 can also be used to group the I/O channels according type (such as analog input, analog output, digital input, digital output, digital input sequence of events, and pulse accumulator). The tool 112 can further present the identified I/O channels or I/O channel groupings in a user interface. The user interface supports options for reserving free channels, freeing reserved channels, reconciling used channels post-project, and reviewing channel statuses. Among other things, this tool 112 can be used for any new or existing project (both encompassed by the term “project”). Optimal management of spare I/O channels can help to reduce inventory and maintain industrial plants more efficiently and economically.

The tool 112 could also support additional functions to facilitate management or control over the I/O channels. For example, users could customize settings so that system-generated alerts are created in response to various conditions, such as when alerts are generated if a number or percentage of available spare I/O channels drops below a specified level. The tool 112 could also be integrated with an inventory management system using SAP or other mechanisms, which allows the tool 112 to provide information about the I/O channels to the inventory management system to support functions like optimal management of inventory.

Each instance of the tool 112 could be implemented in any suitable manner. For example, the tool 112 could be implemented using hardware or a combination of hardware and software/firmware instructions. In this example, one instance of the tool 112 is implemented on an operation station 110. However, any number of tools 112 could be implemented within a system, and the tool(s) 112 could be implemented using any suitable device(s). Additional details regarding the tool 112 are provided below.

Although FIG. 1 illustrates a portion of one example industrial process control and instrumentation system 100, various changes may be made to FIG. 1. For example, various components in FIG. 1 could be combined, further subdivided, rearranged, or omitted and additional components could be added according to particular needs. Also, while FIG. 1 illustrates one example operational environment in which the identification and management of I/O channel spares could be used, this functionality could be used in any other suitable system.

FIG. 2 illustrates an example device 200 for identifying and managing I/O channel spares for control and instrumentation systems in industrial plants according to this disclosure. The device 200 could, for example, denote the operator station 110 in FIG. 1 used to implement the tool 112. However, the device 200 could be used in any other suitable system, and the tool 112 could be implemented using any other suitable device.

As shown in FIG. 2, the device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device.

Although FIG. 2 illustrates one example of a device 200 for identifying and managing I/O channel spares for control and instrumentation systems in industrial plants, various changes may be made to FIG. 2. For example, various components in FIG. 2 could be combined, further subdivided, rearranged, or omitted and additional components could be added according to particular needs. Also, computing devices come in a wide variety of configurations, and FIG. 2 does not limit this disclosure to any particular configuration of computing device.

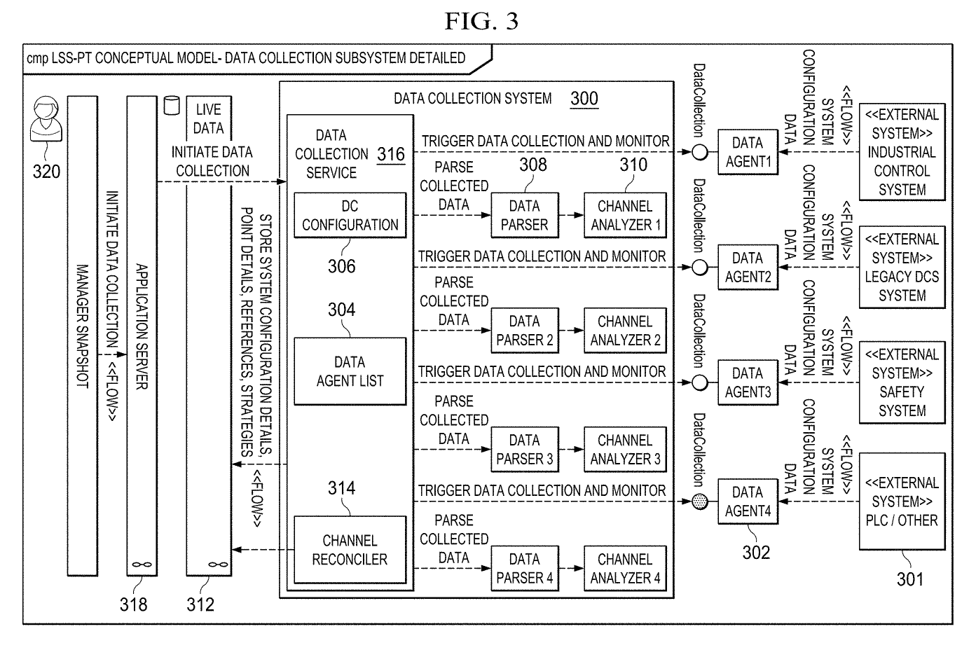

FIG. 3 illustrates an example data collection system 300 for identifying and managing I/O channel spares for control and instrumentation systems in industrial plants according to this disclosure. The data collection system 300 could, for example, be used to implement the tool 112 for identifying and managing spare I/O channels in I/O modules 104. For ease of explanation, the data collection system 300 is described with respect to the system 100 of FIG. 1, although the data collection system 300 could be implemented in any other suitable system. Also, the data collection system 300 could be implemented using the device 200 of FIG. 2, although the data collection system 300 could be implemented in any other suitable manner

As shown in FIG. 3, the data collection system 300 is used in conjunction with one or more source systems 301 from which data is to be collected. Each source system 301 denotes any suitable source of data that relates to the use of I/O channels in an industrial process control and instrumentation system. For example, each source system 301 could denote an industrial process control system, a legacy distributed control system (DCS), a safety system, a programmable logic controller (PLC), or other source of industrial process-related data. While four types of source systems 301 are shown in FIG. 3, the data collection system 300 could be used with any suitable type(s) and any suitable number(s) of source systems.

One or more data agents 302 are used to collect information from the one or more source systems 301. For example, the one or more data agents 302 could collect information related to the use of I/O channels in an industrial process control and instrumentation system from the one or more source systems 301. The one or more data agents 302 have knowledge of the one or more source systems 301 from which data is to be collected and use this knowledge to collect the desired information from the one or more source systems 301.

Each data agent 302 includes any suitable structure for collecting information from at least one data source. The data agents 302 can be executed locally in the source systems 301 or remotely from the source systems 301 using any suitable devices. Although shown as being separate from the data collection system 300, one, some, or all of the data agents 302 could form part of the data collection system 300. Each of the data agents 302 can be developed using suitable technology for implementation within or for a source system 301. New data agents 302 can also be developed and deployed to support new releases of source systems 301. While the system is shown as supporting a one-to-one relationship between source systems 301 and data agents 302, this is not required.

The data collection system 300 is responsible for starting and tracking actual data collection activities for the source systems 301. Internally, the data collection system 300 can include at least one data agent list 304, which can store a list of the data agents 302 that are registered with the data collection system 300. The data agent list 304 can also store information identifying which data agents 302 are applicable for different sources of information (such as for different control systems along with versions of the control systems). At least one data collection (DC) configuration 306 can store a list of source systems 301 from which data can be collected. The data collection configuration 306 can also store connectivity information, which can be used to connect to the control systems or other source systems 301. In addition, the data collection configuration 306 can store credentials to be used by the data agents 302 to gain access to system data of the source systems 301. Each data agent list 304 includes any suitable structure containing information associated with data agents that are used to access and retrieve information. Each data collection configuration 306 includes any suitable structure containing information associated with data sources to be accessed.

For each source system 301, a data agent 302 can be used to collect data, and the data agents 302 can be orchestrated and monitored by the data collection system 300. Also, a data parser 308 can parse the data from each source system 301 in order to prepare the data for storage or use. For instance, the data parsers 308 can parse the data into a common generic or proprietary format. This may allow, for example, data from all of the source systems 301 to be stored in the same common format. Each data parser 308 includes any suitable structure for parsing data into a desired format.

The output of each parser 308 can be provided to a channel analyzer 310. Each channel analyzer 310 can receive the data from a source system 301 and identify I/O channels associated with that source system 301 based on the data from that source system 301. Each channel analyzer 310 can also identify details for each I/O channel, such as I/O type, channel type, and spare or used status based on the data from that source system 301. The channel analyzer 310 can identify the I/O channels and the related details in any suitable manner For example, the data parsers 308 could output data in the common format, and the channel analyzers 310 could use specific data in the common format to identify the I/O channels and the related details. Each channel analyzer 310 includes any suitable structure for identifying I/O channels.

The outputs of the channel analyzers 310 can be provided to a database 312 for storage and later use. Data in the database 312 can be stored for any desired length of time and used in any suitable manner For instance, data can be retrieved from the database 312 in order to generate content for a graphical user interface. The database 312 includes any suitable structure for storing and facilitating retrieval of information.

A channel reconciler 314 can be responsible for reconciling current channel “spare” states with ones stored in a previous snapshot of I/O channel statuses, thereby identifying if there are any changes in channel statuses for the I/O channels. For example, a “spare” I/O channel in a prior snapshot may be changed to a “used” status in a current snapshot, or a “used” I/O channel in the prior snapshot may be changed to a “spare” status in the current snapshot. Channels can be flagged accordingly in the database 312. The channel reconciler 314 includes any suitable structure for reconciling I/O channel states.

In some embodiments, a data collection service 316 denotes a service that implements an information system used to store collected data from various systems. The data collection service 316 can help to guarantee the atomicity, consistency, isolation, and durability of collected snapshot data. The data collection service 316 can also provide any necessary interfaces that can be used by an application server 318 to access data.

The application server 318 can be responsible for interacting with users 320 to, for example, receive requests to initiate snapshots of I/O channels. The application server 318 could also present a graphical user interface or provide data for a graphical user interface to an end user device, such as a desktop computer, laptop computer, tablet computer, or mobile smartphone. As noted above, the graphical user interface could support options for reserving free channels, freeing reserved channels, reconciling used channels post-project, and reviewing channel statuses.

A communication mechanism between the data collection service 316 and the data agents 302 need not be fixed. Rather, the data collection service 316 may use different communication mechanisms to invoke and control different data agents 302. The specific communication mechanism for a data agent 302 can depend on the platform of the target system 301 and the technology in which the data agent 302 is developed.

Each component shown in FIG. 3 could be implemented in any suitable manner. For example, most of the components shown in FIG. 3 could be implemented using software/firmware instructions that are executed by a server or other computing device (such as the device 200). The database 312 could be implemented using any suitable storage and retrieval device(s).

Although FIG. 3 illustrates one example of a data collection system 300 for identifying and managing I/O channel spares for control and instrumentation systems in industrial plants, various changes may be made to FIG. 3. For example, various components in FIG. 3 could be combined, further subdivided, rearranged, or omitted and additional components could be added according to particular needs. Also, the functional arrangement in FIG. 3 is for illustration only, and other implementations performing the same or similar functions could be used.

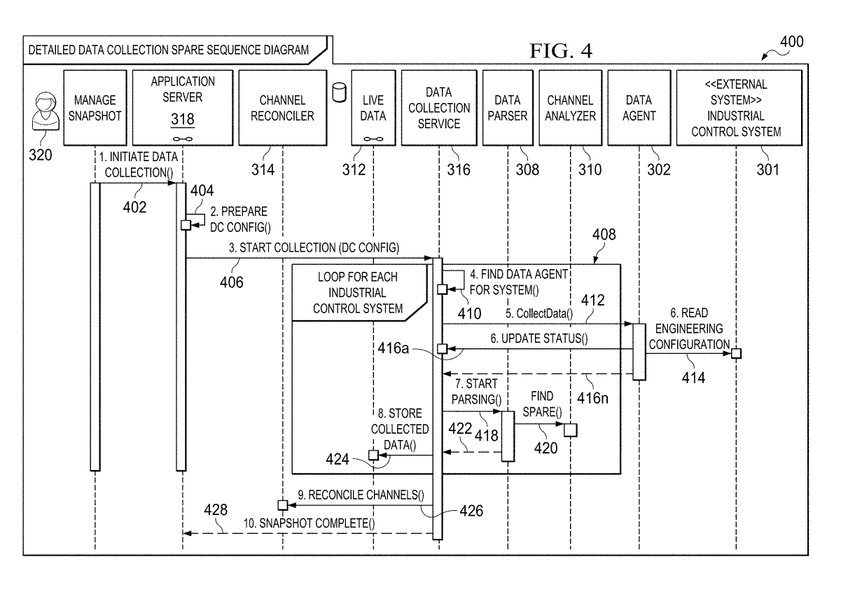

FIG. 4 illustrates an example sequence chart 400 for identifying and managing I/O channel spares for control and instrumentation systems in industrial plants according to this disclosure. In particular, FIG. 4 illustrates an example sequence chart for identifying and managing I/O channel spares that can be performed using the data collection system 300. Note, however, that the same general sequence of operations could occur using any suitable device or system.

As shown in FIG. 4, the process begins when a user 320 initiates a request 402 for data collection to the application server 318. The request 402 could be provided in any suitable manner, such as when the user 320 selects an option in a graphical user interface being presented on an end-user device, such as within a web-based or other user interface. In response to the request 402, the application server 318 prepares a data collection configuration 404. This could include, for example, the application server 318 generating a list of source systems 301 to be accessed. The application server 318 sends a start command 406 to the data collection service 316, and the start command 406 can include the data collection configuration 404.

A loop 408 can then be performed for each source system 301 from which data is to be obtained by the data collection service 316. As part of the loop 408, the data collection service 316 identifies a data agent 302 for one of the source systems 301 during operation 410. The data collection service 316 then sends a collect data command 412 to the identified data agent 302. The collect data command 412 could denote a generic command that merely requests that the identified data agent 302 initiate a data collection process, or the collect data command 412 could denote a specific command requesting that the identified data agent 302 collect specific data from a source system 301. The data agent 302 reads engineering configurations or other data from the source system 301 during operation 414, and one or more status messages 416a-416n are sent from the data agent 302 to the data collection service 316 updating the data collection service 316 on the data agent's status.

At some point (such as during or after collection of data from a source system 301), the data collection service 316 sends a start parsing command 418 to the data parser 308 associated with the source system 301. The data parser 308 parses the data and sends a find spare command 420 to the appropriate channel analyzer 310, which analyzes the parsed data to identify spare I/O channels. Results 422 of the parsing or data analysis are provided to the data collection service 316 for storage in the database 312 during operation 424. A reconcile channels command 426 can also be provided to the channel reconciler 314, which analyzes the results 422 to identify status changes in I/O channels. In addition, a snapshot complete command 428 is sent to the application server 318, informing the application server 318 that a snapshot of the I/O channels is complete. The snapshot could, for instance, identify the statuses of the identified I/O channels, along with details related to the I/O channels (such as which user reserved a channel, when the channel was reserved, etc.). The application server 318 could then take any suitable action, such as retrieving data from the database 312 related to the snapshot for presentation to the user 320 via the user interface.

Although FIG. 4 illustrates one example of a sequence chart 400 for identifying and managing I/O channel spares for control and instrumentation systems in industrial plants, various changes may be made to FIG. 4. For example, the components of the data collection system 300 could be used in any other suitable manner. Also, as noted above, other devices or systems could be used to perform the various data collection and analysis operations described above.

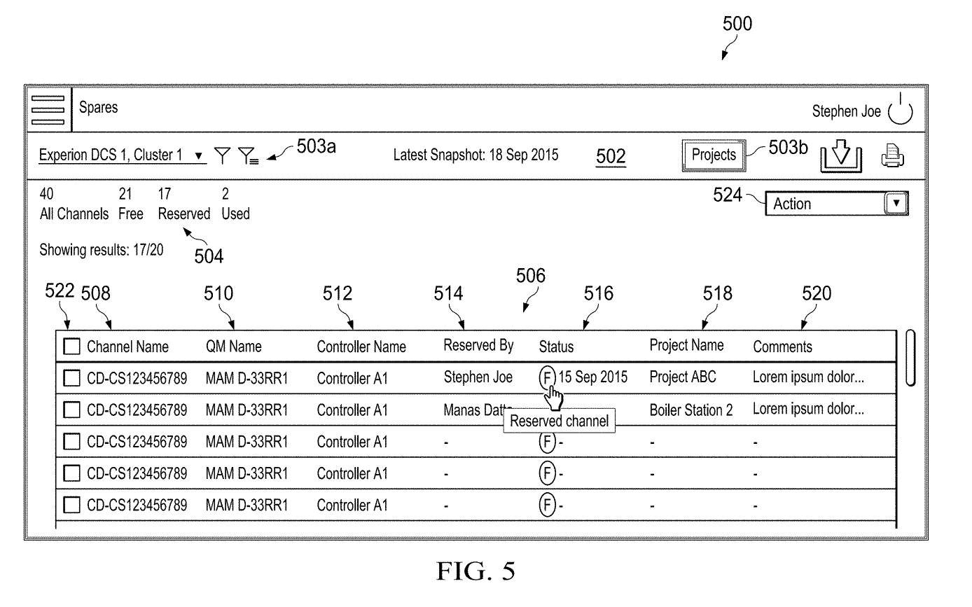

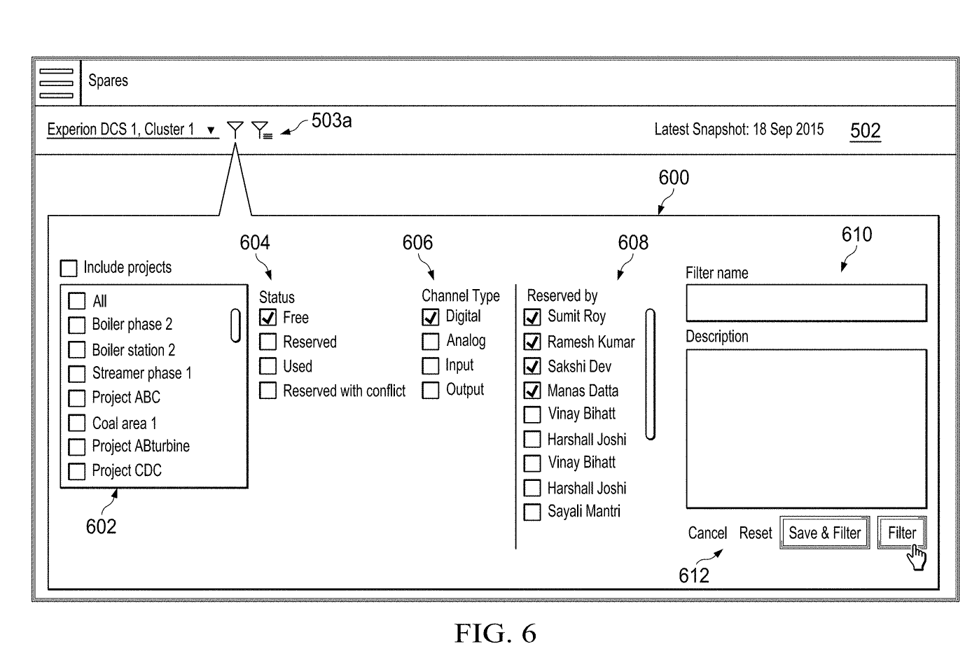

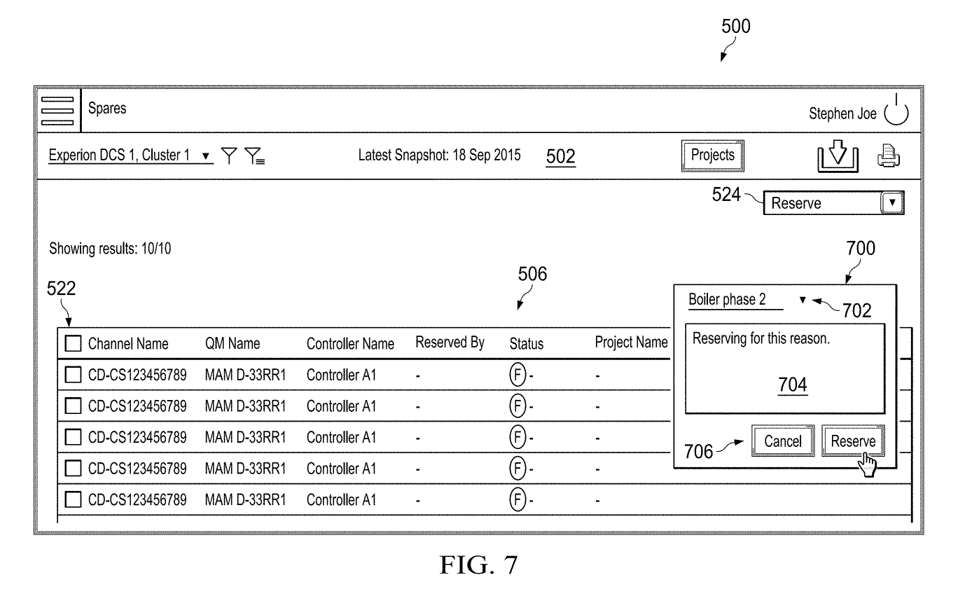

FIGS. 5 through 7 illustrate an example graphical user interface for identifying and managing I/O channel spares for control and instrumentation systems in industrial plants according to this disclosure. The graphical user interface can be used in various circumstances to provide desired information or functions to users. For example, once channel-related data is updated in the database 312, the application server 318 can start utilizing the data to provide information related to spare I/O channels in a user interface (FIG. 5), to filter I/O information (FIG. 6), or to change an I/O channel status (FIG. 7). Note, however, that the graphical user interface shown here could be used by any other suitable device and in any other suitable system.

As shown in FIG. 5, a graphical user interface 500 provides information related to spare I/O channels identified in an industrial process control and instrumentation system. For example, the graphical user interface 500 could identify details about the spare I/O channels identified using the data collection system 300 described above.

In this example, the graphical user interface 500 includes a header section 502 that provides high-level information to a user. In this particular example, the header section 502 identifies a selected portion of an industrial process control and instrumentation system and a date that an I/O snapshot was last captured for the selected portion of the industrial process control and instrumentation system. The header section 502 also includes controls 503a for selecting a portion of an industrial process control and instrumentation system and filtering the contents of the graphical user interface 500. In particular, the left control 503a allows a user to select a portion of an industrial process control and instrumentation system, the middle control 503a allows a user to define filtering criteria, and the right control 503a allows a user to select a previously-defined filter. In some embodiments, the left control 503 could allow a user to view channel information according to source system, I/O module, and/or channel type or provide a user with options to select a system and see a complete list of I/O modules, its used channels, and each channel's free/spare status. The header section 502 further includes controls 503b for performing various actions, such as selecting a project, downloading a report, or printing a report.

The graphical user interface 500 also includes a summary section 504 that provides summary information related to I/O channels of the selected portion of the industrial process control and instrumentation system. The summary section 504 here identifies the total number of I/O channels for the selected portion and the numbers of free, reserved, and used I/O channels for the selected portion. A free channel denotes an I/O channel that is available for reservation or use. A reserved channel denotes an I/O channel that is not currently in use but that has been reserved for later use by a user. A used channel denotes an I/O channel that is currently in use.

The graphical user interface 500 further includes a table 506 containing information about the I/O channels of the selected portion of the industrial process control and instrumentation system. In this example, for each I/O channel, the table 506 identifies a name 508 of the I/O channel, a name 510 of the I/O module (IOM) associated with the I/O channel, and a name 512 of the controller associated with the I/O channel. The table 506 also includes a name 514 of a user who reserved an I/O channel (or a dash if the I/O channel is not reserved). The table 506 further includes a status 516, a project name 518, and comments 520 for the I/O channels. In some embodiments, the status 516 could include one indicator (such as a circled “R” value) and a date when an I/O channel was reserved, or the status 516 could include another indicator (such as a circled “F” value) without an associated date if the I/O channel is not reserved. Other status indicators could also be used. The project name 518 could be used to identify the project or other task for which an I/O channel has been reserved, and the comments 520 could contain user comments related to I/O channels.

A selector 522 (a checkbox in this case) can be provided in the table 506 and used to select one, some, or all I/O channels in the table 506. Once selected, a control 524 could be used to apply a function to the selected I/O channel(s). For example, a user could use the selectors 522 to select those I/O channels, and the user could then use the control 524 to reserve the selected I/O channels, free the selected I/O channels so that others can reserve those channels, or mark the I/O channels as being in use and no longer available for use as spare channels.

As shown in FIG. 6, one of the filtering controls 503a has been selected, namely the middle control 503a that allows a user to provide one or more filtering criteria and optionally to save the filtering criteria as a filter. The right control 503a could be used to access previously-saved filters. When the middle control 503a is selected, a new window 600 is presented within the graphical user interface 500.

The window 600 contains various options for filtering the I/O channels presented in the table 506. For example, options 602 can be used to control the display of I/O channels associated with particular projects. Options 604 can be used to control the display of I/O channels based on their status, such as statuses like free, reserved, used, or reserved with conflict (meaning multiple parties are trying to reserve the same I/O channel). Options 606 can be used to control the display of I/O channels based on their channel types, such as channel types like analog, digital, input, or output. Options 608 can be used to control the display of I/O channels based on the users who have reserved the I/O channels. Options 610 allow a user to optionally create a filter name and description, and controls 612 (among other things) allow the user to filter the I/O channel data without saving the filter (“Filter”) or to filter the I/O channel data and save the filter criteria (“Save & filter”).

As shown in FIG. 7, one or more of the I/O channels in the table 506 have been selected via their corresponding selectors 522, and the control 524 has been selected to reserve the selected I/O channels. A new window 700 is then presented within the graphical user interface 500 allowing the user to enter information about the selected I/O channel(s) being reserved. For example, a drop-down control 702 can be used to select the project for which the selected I/O channels are being reserved or to select an option to create a new project. Also, a text box 704 can be used to receive user comments about the selected I/O channels, such as why the selected I/O channels are being reserved. The contents of the text box 704 could later appear as or within the comments 520 for the selected I/O channels. Controls 706 can be used to save or cancel the reservation.

As noted above, one of the statuses that can be associated with an I/O channel is “reserved with conflict,” which indicates that multiple users wish to reserve the same I/O channel. In embodiments supporting conflicting reservations, the graphical user interface 500 may not prevent one user from attempting to reserve at least one I/O channel previously reserved by another user. Rather, the two users involved in the conflicting reservations could work out amongst themselves which reservation has priority, or the tool 112 could support a hierarchy of users where higher-level users can override reservations made by lower-level users. In other embodiments, the tool 112 could allow only a single user to reserve a channel and not support conflicting reservations.

Although FIGS. 5 through 7 illustrate one example of a graphical user interface for identifying and managing I/O channel spares for control and instrumentation systems, various changes may be made to FIGS. 5 through 7. For example, the contents and arrangements shown in FIGS. 5 through 7 are for illustration only. Also, while specific input/output mechanisms (such as checkboxes, text boxes, buttons, or pop-up boxes) are shown here, any other suitable mechanisms could be used for input or output of data.

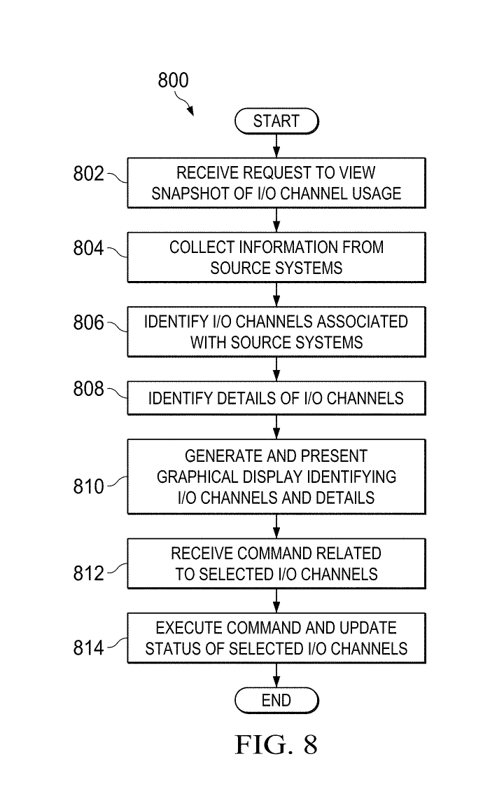

FIG. 8 illustrates an example method 800 for identifying and managing I/O channel spares for control and instrumentation systems in industrial plants according to this disclosure. For ease of explanation, the method 800 is described with respect to the system 100 of FIG. 1, although the method 800 could be implemented in any other suitable system. Also, the method 800 could be implemented using the device 200 of FIG. 2, although the method 800 could be implemented in any other suitable manner.

As shown in FIG. 8, a request to view a snapshot of I/O channel usage is received at step 802. This could include, for example, the one or more processors 202 of the device 200 executing an application that supports the graphical user interface 500. This could also include the processor(s) 202 receiving a request for the snapshot through the graphical user interface, such as when a user 320 selects a command to view the I/O channels for a given portion of an industrial process control and instrumentation system (like via the left control 503a).

Information from one or more source systems is collected at step 804, and the information is used to identify I/O channels at step 806 and to identify details of the I/O channels at step 808. This could include, for example, the processor(s) 202 of the device 200 receiving information collected by one or more data agents 302 from one or more source systems 301. This could also include the processor(s) 202 of the device 200 parsing the collected information into a common format. This could further include the processor(s) 202 of the device 200 using the collected information to identify I/O channels of the source systems 301 and related details like each I/O channel's type, the I/O module associated with each channel, the controller associated with each channel, and the I/O channel's status (like used or free).

At least one graphical display is generated identifying at least some of the I/O channels and at least some of the related details and presented to a user at step 810. This could include, for example, the processor(s) 202 of the device 200 generating a table 506 containing information about various I/O channels, such as all I/O channels or a subset of I/O channels that satisfies search or filtering criteria of the user.

A command related to one or more selected I/O channels is received at step 812, and the command is executed and a status of the selected I/O channel(s) is updated at step 814. This could include, for example, the processor(s) 202 of the device 200 receiving a selection of one or more I/O channels via the graphical user interface, such as via the selectors 522 in the table 506. If the command is to reserve the selected I/O channel(s), the processor(s) 202 of the device 200 can update the status of the selected I/O channel(s) in the database 312 with information like the user who reserved each channel, the project for each channel, and any comments for each channel (which could be received from the user via the window 700 of the graphical user interface 500). If the command is to free the selected I/O channel(s), the processor(s) 202 of the device 200 can update the status of the selected I/O channel(s) in the database 312 to indicate each channel is now free for use. If the command is to mark the selected I/O channel(s) as being in use, the processor(s) 202 of the device 200 can update the status of the selected I/O channel(s) in the database 312 to indicate each channel is now actually in use and not free for reservation.

Although FIG. 8 illustrates one example of a method 800 for identifying and managing I/O channel spares for control and instrumentation systems in industrial plants, various changes may be made to FIG. 8. For example, while shown as a series of steps, various steps in FIG. 8 could overlap, occur in parallel, occur in a different order, or occur any number of times. As a particular example, steps 804-808 could occur repeatedly (such as at periodic intervals or at other times) and need not occur in response to a user request. As other particular examples, step 802 could occur after steps 804-808, and steps 812-814 could occur any number of times depending on the number of commands provided by a user.

Among other things, the systems and methods disclosed in this patent document may include the following unique and novel features (any one or combination of which could be supported in a given implementation):

query each source system from which data is to be collected in order to identify all I/O modules present in those systems, the type of each I/O module, and channel usage details (such as used versus free);

group the information according to source system, I/O module, and/or channel type;

provide users with options to select a system and see a complete list of I/O modules, its used channels, and each channel's free/spare status;

provide users with further options to filter a list of I/O channels by selecting specific module types, channel types, or free/used statuses and see the results per the matching criteria created using filtering options;

provide users with the ability to save a filter list created to query free versus used channel statuses of specific modules/channel types for future usage;

provide users with the option to select one or multiple free channels from a table and reserve those channels for a project;

provide users with the option to create a project with a name and a description, where projects created by users can be available and used to assign channels for reservation;

provide the ability, once one or more channels are reserved for a project, to show the status of those channels as “reserved” to all users querying free/used status of those channels, with further details like who reserved those channels and on what date the channel was reserved;

provide users with the option to free reserved channels and dissociate those channels from a project;

provide users with an ability, once reserved channels get consumed in source systems (either by a project for which the channels were reserved or some other project uses those channels before an actual project can consume those channels), to show the status of those channels with different icons, which can help users to identify that channels are no longer free;

provide users with the ability to select channels and reconcile those channels with additional comments if the channels are used by an intended project (once reconciled, the status of those channels can be automatically changed to “used”);

provide bidirectional traceability of channels and corresponding projects in which the channels are used; and

integrate the history of channel usage into a centralized documentation system so that the channel usage history can be used for reviews, audits, or other functions.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying input/output (I/O) channels in a control and instrumentation system associated with an industrial plant;
identifying which of the I/O channels are not in use by the control and instrumentation system; and
generating a graphical user interface identifying the I/O channels not in use by the control and instrumentation system.

2. The method of claim 1, further comprising:
receiving, via the graphical user interface, an indication that at least one of the I/O channels not in use by the control and instrumentation system is being reserved for use; and
reserving the at least one I/O channel

3. The method of claim 2, further comprising:
receiving, via the graphical user interface, at least one of a project and a comment associated with the at least one I/O channel being reserved for use; and
associating the at least one the project and the comment with the at least one I/O channel.

4. The method of claim 1, further comprising:
receiving, via the graphical user interface, an indication that at least one of the I/O channels in use by the control and instrumentation system is now not in use by the control and instrumentation system; and
releasing the at least one I/O channel so that the at least one I/O channel is available for reservation or other use.

5. The method of claim 1, wherein identifying the I/O channels comprises:
identifying I/O modules in the control and instrumentation system; and
identifying I/O channels of the I/O modules.

6. The method of claim 1, further comprising:
grouping the identified I/O channels in different groups by at least one of: source system, I/O module, and channel type;
wherein the graphical user interface identifies the I/O channels as grouped.

7. The method of claim 1, further comprising:
receiving one or more filtering criteria from a user;
wherein the graphical user interface identifies any I/O channels satisfying the one or more filtering criteria.

8. An apparatus comprising:
at least one processing device configured to:
identify input/output (I/O) channels in a control and instrumentation system associated with an industrial plant;
identify which of the I/O channels are not in use by the control and instrumentation system; and
generate a graphical user interface identifying the I/O channels not in use by the control and instrumentation system.

9. The apparatus of claim 8, wherein the at least one processing device is further configured to:
receive, via the graphical user interface, an indication that at least one of the I/O channels not in use by the control and instrumentation system is being reserved for use; and
reserve the at least one I/O channel.

10. The apparatus of claim 9, wherein the at least one processing device is further configured to:
receive, via the graphical user interface, at least one of a project and a comment associated with the at least one I/O channel being reserved for use; and
associate the at least one the project and the comment with the at least one I/O channel.

11. The apparatus of claim 8, wherein the at least one processing device is further configured to:
receive, via the graphical user interface, an indication that at least one of the I/O channels in use by the control and instrumentation system is now not in use by the control and instrumentation system and is available for reservation or other use; and
release the at least one I/O channel so that the at least one I/O channel is available for reservation or other use.

12. The apparatus of claim 8, wherein the at least one processing device is further configured to:
receive a user-defined condition associated with the I/O channels not in use by the control and instrumentation system; and
generate an alert when the condition associated with the I/O channels not in use by the control and instrumentation system is satisfied.

13. The apparatus of claim 8, wherein the at least one processing device is further configured to provide information about the I/O channels to an inventory management system.

14. The apparatus of claim 8, wherein:
the at least one processing device is further configured to receive one or more filtering criteria from a user; and
the graphical user interface is configured to identify any I/O channels satisfying the one or more filtering criteria.

15. A non-transitory computer readable medium containing instructions that, when executed by at least one processing device, cause the at least one processing device to:
identify input/output (I/O) channels in a control and instrumentation system associated with an industrial plant;
identify which of the I/O channels are not in use by the control and instrumentation system; and
generate a graphical user interface identifying the I/O channels not in use by the control and instrumentation system.

16. The non-transitory computer readable medium of claim 15, further containing instructions that when executed cause the at least one processing device to:
receive, via the graphical user interface, an indication that at least one of the I/O channels not in use by the control and instrumentation system is being reserved for use; and
reserve the at least one I/O channel.

17. The non-transitory computer readable medium of claim 16, further containing instructions that when executed cause the at least one processing device to:
receive, via the graphical user interface, at least one of a project and a comment associated with the at least one I/O channel being reserved for use; and
associate the at least one the project and the comment with the at least one I/O channel.

18. The non-transitory computer readable medium of claim 15, further containing instructions that when executed cause the at least one processing device to:
receive, via the graphical user interface, an indication that at least one of the I/O channels in use by the control and instrumentation system is now not in use by the control and instrumentation system and is available for reservation or other use; and
release the at least one I/O channel so that the at least one I/O channel is available for reservation or other use.

19. The non-transitory computer readable medium of claim 15, wherein the instructions that when executed cause the at least one processing device to identify the I/O channels comprise:
instructions that when executed cause the at least one processing device to identify I/O modules in the control and instrumentation system and identify I/O channels of the I/O modules.

20. The non-transitory computer readable medium of claim 15, further containing instructions that when executed cause the at least one processing device to group the identified I/O channels in different groups by at least one of: source system, I/O module, and channel type; and
wherein the graphical user interface is configured to identify the I/O channels as grouped.

21. The non-transitory computer readable medium of claim 15, further containing instructions that when executed cause the at least one processing device to receive one or more filtering criteria from a user;
wherein the graphical user interface is configured to identify any I/O channels satisfying the one or more filtering criteria.
